(19) United States
(12) Patent Application Publication
(10) Pub. No.: US 2007/0106913 A1
(43) Pub. Date: May 10, 2007

(54) Implementing power over network data link for systems utilizing multiple power sources

(76) Inventors: Jonathan F. Lewis, Pflugerville, TX (US); Andrew T. Sultenfuss, Leander, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/268,358

(22) Filed: Nov. 7, 2005

(51) Int. Cl. G06F 1/26

(52) U.S. Cl. 713/300

(57) ABSTRACT

A technique is disclosed for utilizing power provided from a data communication line for operation of an information handling system. The power from the data communication line may be utilized even when the information handling system being powered requires more power than is available from the data communication line. More particularly, power management techniques are provided that couples the power from a data communication line to the power systems of the information handling system. The information handling system may include a plurality of power sources of which the data communication line power is just one such source. Power management circuitry identifies and characterizes the power available from the data communication line and integrates the power with the power available from other power sources. In one embodiment the data communication line may be an Ethernet connection that operates in accordance with Power Over Ethernet standards.

### TECHNICAL FIELD OF THE INVENTION

This invention relates to techniques for providing power over a network data communication line for systems that have multiple power sources, and more particularly for systems that receive power through power over Ethernet (POE) connections.

### BACKGROUND

Various approaches have been proposed for providing network data communications and power over the same infrastructure. One well known wired network data communication standard is the Ethernet standard. Providing power over Ethernet cabling in while still allowing Ethernet data communication is known as power over Ethernet (POE). One standard for providing power over Ethernet cabling is the IEEE 802.3af standard. Some of the first applications utilized for POE include Ethernet connected IP telephones, wireless local area network access points and security cameras. Such equipment often has relatively low power requirements that are suited for the generally low power available under the POE standard.

Providing power through network data communication cabling is typically accomplished through the use power sourcing equipment (PSE) such as switches, routers, hubs, etc and powered devices (PD) such as IP phones, wireless access points, client-end devices, etc. In POE applications, the PSE may provide power to the PD through the use of the data wire pairs. The PSE may alternatively also provide power to the PD through the use of “spare” wire pairs in the Ethernet cabling (for applications in which spare wire pairs exist). So that power is not undesirably sent from a PSE to a non-PD device, a multi-stage handshake transpires between the PSE and PD devices. The handshaking process includes signature/detection, classification, power start-up and power disconnect stages. The signature/detection stage involves the PSE probing the PD to see if the PD is POE compliant. The classification stage involves the PD identifying the level of power that the PD requires. The start-up stage involves ramping the supplied voltage to the full voltage level and the disconnect stage disables the provision of power when the PD is determined to have been disconnected.

In POE applications, the PSE may provide a 44-57 V DC voltage level (nominally 48 V DC) to the PD. However, current POE standards generally limit the supplied power to a maximum of 12.95 W at the PD. Many devices that could advantageously receive power over a data communication line, however, require more power than may be available over the data communication line according to current standards. Consideration is being given to new or modified standards that would supply more power to powered devices; however, even such increased power levels may still be unsatisfactory for many applications.

One device for which the power supplied across a data communication line is generally insufficient for standard operation is a personal computer. Even low power computers such as notebook or laptop computers typically require more power than may be available from a data communication line. For example as described above current IEEE POE standards provide a maximum of 12.95 W to a PD. Many notebooks or laptop computers, however, have power requirements in the 65 to 150 W range. It would be desirable to provide a technique to advantageously utilize power supplied across a data communication line even when the PD has higher power requirements than is available from the data communication line.

As the value and use of information continues to increase, individuals and businesses seek additional ways to process and store information. One option available to users is information handling systems. The devices that may utilize power provided across a data communication line are wide ranging and include information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One exemplary prior art information handling system 100 is shown in FIG. 1. In one embodiment, the information handling system may be a laptop or notebook computer. As shown in FIG. 1, the information handling system 100 may receive power from an AC-DC adapter 102 or from one or more rechargeable batteries. The AC-DC adapter converts an external AC voltage (for example from the public power system) to a DC voltage that may be supplied to the information handling system 100. The AC-DC adapter may be any of a variety of different types and classes of adapters as is known in the art. In the example shown two batteries 108 and 110 are provided however other numbers of batteries may be used. The batteries 108 and 110 may be of any of a wide variety of types including lithium ion (LiON), nickel metal hydride (NiMH), nickel cadmium (NiCd), etc. The batteries may be “smart” rechargeable batteries that communicate with other components of the information handling system so as to monitor and control the operation of the battery and charging of the battery as is known in the art. More particularly, power management circuitry 106 may control the distribution of power from the various power sources and the charging of the batteries via control lines 112, 114, 116, and 118. The control lines 112, 114, 116, and 118 may also provide information to the power management circuitry defining the types and classes of the power sources and the current status of those power sources. The power management circuitry 106 is also coupled to charger/selector circuitry 104. The charger/selector circuitry 104 receives power through power lines 120, 122 or 124. The charger/selector circuitry 104 supplies the power to one or more system power planes 126. System power planes 126 may provide power to various system components (for example, processors, memory, drives, displays, fans, etc.) as is known in the art. The charger/selector circuitry 104 may select which power source (AC-DC adapter 102, battery 108 or battery 110) from which power is supplied to the power plane 126. Charger/selector circuitry 104 also operates as the circuitry through which power from the AC-DC adapter is utilized to charge the batteries 108 and 110. The power management circuitry 106 may include a controller and BIOS that communicates with the batteries, AC-DC adapter and the charger/selector circuitry so as to properly select the power source, set power usage settings, control battery charging, etc. Moreover, by recognizing the classes and types of AC-DC adapters and batteries being utilized, the power management may be optimized. Power management circuitry may optionally also communicate with other system components (not shown) so as to power down, suspend, hibernate, etc. the other components of the information handling system so as to optimize the conservation of power resources.

### SUMMARY OF THE INVENTION

A method and system are disclosed for utilizing power provided from a data communication line for operation of an information handling system. The power from the data communication line may be utilized even when the information handling system being powered requires more power than is available from the data communication line. More particularly, power management techniques are provided that couples the power from a data communication line to the power systems of the information handling system. The information handling system may include a plurality of power sources of which the data communication line power is just one such source. Power management circuitry identifies and characterizes the power available from the data communication line and integrates the power with the power available from other power sources. Thus, the information handling system may operate from power available from the data communication line in conjunction with power from one or more other power sources. The multiple power sources may be utilized together to operate the information handling system. The data communication line power may also be utilized to charge a battery when the information handling system is turned off or if the system is operating from one of the other power sources. The information handling system may also operate with power solely supplied from the data communication line, for example when the system is in a suspend or hibernate mode. In one embodiment, the data communication line may be an Ethernet connection through which POE techniques are implemented.

In another embodiment, a method of managing the power resources of an information handling system is provided. The method may include providing a low power data network power connection within the information handling system for obtaining power from a network connection through which data is also provided. The method may further include identifying and qualifying the power that is available from the data network and providing information regarding the power that is available from the data network to the information handling system so as to manage the power resources of the information handling system.

In another embodiment, a method of controlling the power management system within an information handling system is provided. The method may include providing power management control circuitry and coupling the power management control circuitry to network power control circuitry, the network power control circuitry configured to receive power from a data network for operating at least in part at least a portion of the information handling system. The method may further include providing feedback and control amongst the power management control circuitry, the data network power control circuitry, and the at least one of power source.

In still another embodiment, an information handling system is disclosed. The information handling system may include at least one battery coupled to the information handling system for providing power to the information handling system and a data network power circuit configured to be coupled to at least one data network line to receive power from a data network. The information handling system may further include system power management resources coupled to both the battery and the data network power circuit; the system power management resources configured to enable power to be utilized by the information handling system from both the at least one battery and the data network together.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 illustrates a prior art information handling system.

FIG. 2 illustrates an information handling system utilizing a plurality of power sources including a power source supplied over a data communication line.

FIG. 3 illustrates an exemplary power source control circuit for receiving power from a data communication line.

### DETAILED DESCRIPTION OF THE INVENTION

As described in more detail below, a technique is disclosed herein for utilizing power provided from a data communication line for operation of an information handling system. The power from the data communication line may be utilized even when the information handling system being powered requires more power than is available from the data communication line.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

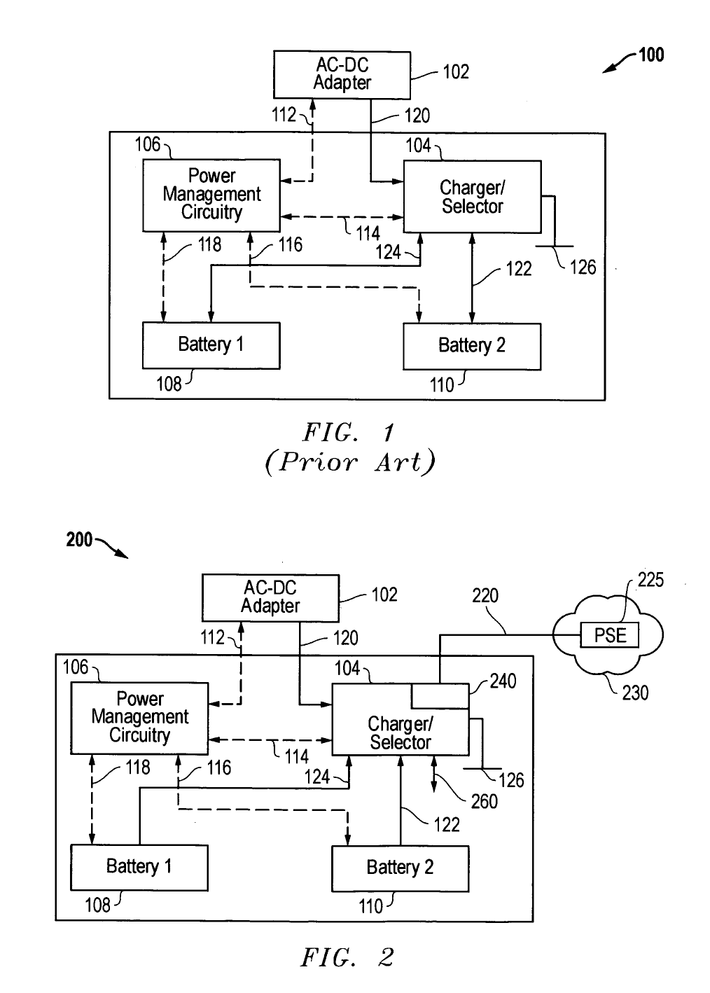

FIG. 2 illustrates an exemplary information handling system 200 that may utilize the power management techniques that are described herein. As shown in FIG. 2, the information handling system 200 (such as, for example, a notebook or laptop computer) may include elements similar to the information handling system 100 of FIG. 1 with like reference numbers utilized for similar elements. The information handling system 200 further includes the coupling of a data communication line 220 through which power and data may be supplied to the information handling system (such as for example an Ethernet connection which supplies POE power). The data communication line 220 is connected to a network 230 to transmit data between the network 230 and the information handling system 200. The network 230 includes at least one PSE that operates as a power source. The charger/selector 204 and the power management circuitry 206 operate to provide similar functionality as the charger/selector circuitry 104 and the power management circuitry 106 of FIG. 1 with the additional functionality of receiving and managing power and data supplied via data communication line 220. Data may be provided to/from other system resources and buses of the information handling system 200 through data lines 260.

Thus, as shown in FIG. 2 three types of power sources are provided: AC-DC adapter, data communication line and batteries. As described above, the AC-DC adapter and batteries may be one of a number of types and classes of devices having various voltage and power levels. Also it will be recognized that the techniques described herein may be utilized with more or less types of power sources and the embodiment of FIG. 2 is meant only to be exemplary. In particular, the information handling system may include a plurality of power sources of which the data communication line power is just one such source. Power management circuitry identifies and characterizes the power available from the data communication line and integrates the power with power available from other power sources. The information handling system may operate from power available from the data communication line in conjunction with power from one or more other power sources. Thus, multiple power sources may be utilized together. The data communication line power may also be utilized to charge one or more batteries when the information handling system is turned off or if the system is operating from one of the other power sources. The information handling system may also operate with power solely supplied from the data communication line, for example when the system is in a suspend or hibernate mode.

In addition to communication with the AC-DC adapter, the batteries and the charger/selector, the power management circuitry 206 may communicate with network power control circuitry 240. The network power control circuitry 240 may indicate the availability of power on the data communication line 220. The availability of such power may then be communicated such to the power management circuitry 206. In addition, the network power control circuitry 240 may characterize the power available from the network according to voltage, current, maximum wattage, stability, etc. and feed such information to the power management circuitry 206. Power management circuitry 206 may then incorporate the power provided by the network in a manner to efficiently operate the information handling system and/or charge the batteries. The power management circuitry 206 may also communicate with the power control circuitry 240 to indicate a current system status in which power from the data network is not needed by the information handling system 100. In circumstances in which the additional power from the data network is not needed by the system, the power control circuitry 240 (and/or PD circuitry within the power control circuitry 240) may communicate with the PSE to indicate that the information handling system 100 will not accept power from the PSE. Thus, power at the network 230 level may be directed towards other systems requiring power or simply conserved.

For example, if AC power is not connected, the power from the network and one or more batteries may be combined to supply power to the power planes 126. Alternatively, the power planes 126 may be operated from one battery while the data network supplied power is utilized to charge the other battery. Further, the network supplied power may be utilized to charge all batteries when the system is turned off. In still yet another embodiment, the power from the data network may be the sole power source utilized to power the information handling system, particularly when the system is placed in a low power consumption mode of operation such as a suspend or hibernate modes. In yet another embodiment, the power from the data network may be utilized to support advanced system management features. For example, the power from the data network may be utilized to support the low power consumption needs of a system that is shut down in a Wake On LAN mode (a mode where a network adapter has a very-low-power mode to monitor the network for special packet data that will wake up the rest of the system). Thus, it will be recognized that the power from the data network may be utilized in a wide variety of manners when AC power is not connected to the system and the embodiments described herein are merely exemplary.

Though the data network power may be most advantageously utilized if the AC power is unavailable, the data network power may still be utilized even if AC power is available. For example, even though AC power is available, the amount of power available may not be sufficient to for simultaneously utilizing all features of the information handling system. In one example, AC power may be available however the available power may not be sufficient to both operate the information handling system and charge the batteries of the system. In such a circumstance, the additional availability of the data network power may be sufficient such that the system may be operated and the batteries charged.

The data network power may be efficiently utilized even if the available data network power is less than the total power required to operate the information handling system in a normal mode of operation. In this regard, the data network power may be characterized as a low power DC power source. The power management circuitry 206 may integrate the usage of this low power source in combination with some, all, or none of the other higher power sources (for example AC-DC adapter 102, battery 108 and battery 110). By identifying the availability of a secondary low power source and characterizing the power availability from the secondary power source, the power management circuitry may apply the power from the secondary power source in the most efficient manner depending upon the number and type of other power sources, the current power demands of the information handling system, the available charge remaining on the batteries, etc. In this manner although the low power level network power supply may not be self-sufficient for full operations of the information handling system, the network power supply may still significantly enhance power system operations when the information handling system is connected to a network which has power delivery services available.

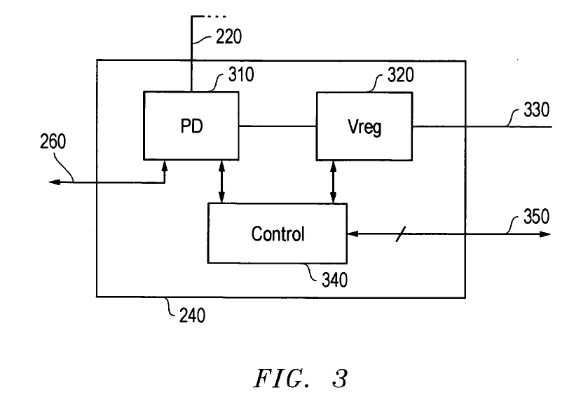

The power control circuitry 240 may include any of wide variety of circuits that receive, identify and/or characterize the data network power. One embodiment related to the POE applications is shown in FIG. 3. As shown in FIG. 3, the power control circuitry 240 may include powered device circuitry 310 that is coupled to the data communication line 220. The powered device circuitry 310 may include known commercially available POE PD circuitry that splits the data from the power and that performs the various PD-PSE handshake operations as described above. After the PD-PSE handshake is completed the power may be provided from the powered device circuitry 310 to a voltage regulator 320 to that performs a DC to DC conversion to regulate the voltage to the an accurate desired voltage level on supply line 330 which may then be provided to the other circuitry of the charger/selector 204. In one embodiment, the output DC voltage on supply line 330 may be programmable so as to match the output voltage level of the AC-DC adapter or so as to provide an optimal voltage level that is dependent upon various system power needs, battery charge states, etc. Data being provided on the data communication line 220 may be provided to the rest of the system resources of the information handling system on data lines 260.

Control circuitry 340 may optionally provide a range of functions. In a simplest form, control circuitry 340 may merely communicate with the powered device circuitry 310 to identify the availability of data network provided powered. This may be indicated on control line(s) 350 that is coupled to the power management circuitry 206 of the information handling system 200. The control line(s) 350 may be configured in accordance with a communication interface standard such as for example, an 12C interface, SMBus interface, SST interface, OneWire interface or other interface standard. The control circuitry 340 may also be configured to provide multiple status signals. For example, the control circuitry may indicate that power is available and an indicator of the characteristics of the power. The indicator may be that the power is within an acceptable range or that there is a fault with the power levels being provided. Furthermore, power detection and characterization circuits may be provided in the powered device circuitry 310 and/or the control circuitry 340 so that more advanced characterization information (voltage, maximum wattage, current, etc.) may be provided on the control line(s) 350. In addition, the control line(s) 350 may provide on, off, reset, control etc. signals to/from the power management circuitry 206 so as to turn on, turn off, or reset the power control circuitry 240, to indicate whether power is available, indicate a high/low power status, or to set the power control circuitry 240 to refuse power from the PSE or sense the current voltage.

Thus, described herein is a method of not only providing power to an information handling system from a data network but also identifying the existence and characteristics of the provided power so that the information handling system may integrate the power available from the data network with one or more other power sources. The techniques described herein provide for a qualification and quantification of the power source available from the data network. This information may then be feed into the power management resources to optimize the overall system power performance. In addition to identifying the power source capabilities to the system, feedback control may be provided to the power control circuitry 240 to further enhance performance.

As shown in FIG. 2, network power control circuitry 240 may be construed to be a portion of the charger/selector 204. Alternatively, while still internal to the information handling system 200 the network power control circuitry may alternatively be construed to be separate from the charger/selector 204. In yet another alternative embodiment the network power control circuitry 240 may be formed external to the information handling system with the supply line 330, data line 360 and the control line(s) 350 coupled to the information handling system.

It will be recognized that the data communication line that provides power as described herein may be any of a wide variety of network hardwired communication lines. For example, a wide variety of hardwire communication standards are known that may advantageously also provide power including USB, IEEE 1394a, Ethernet, extensions to the IEEE 802.3af, other future Ethernet related standards, etc. In general, the techniques described herein may be useful for providing an additional power source from any data communication line through which power may be delivered to system in addition to the data being communicated. Though exemplary embodiments are described herein with regard to Ethernet cabling and POE, it will be recognized with the benefits of this disclosure that the power management techniques are applicable to non-Ethernet data communication.

The techniques described herein may function with prior art power systems by the addition of the power control circuitry 240 and a BIOS update that integrates the management of the data network power source with the other power sources.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention. For example, the various communication protocols described herein (such as 802.11a/b/g/n, UWB, cellular, etc.) are merely exemplary and it will be recognized that other current and future standards may equally utilized the techniques described herein. Furthermore, the prioritization classes described herein are merely exemplary and other classes of traffic and/or other levels of priority may be utilized while still providing the benefits of the concepts disclosed herein.

What is claimed is:

1. A method of managing the power resources of an information handling system, comprising:
providing a low power data network power connection within the information handling system for obtaining power from a network connection through which data is also provided;
identifying and qualifying the power that is available from the data network; and
providing information regarding the power that is available from the data network to the information handling system so as to manage the power resources of the information handling system.

2. The method of claim 1, wherein the network connection is an Ethernet network connection.

3. The method of claim 1, wherein the identifying and qualifying includes determining at least one characteristic of the voltage, current, or wattage of the power that is available from the data network.

4. The method of claim 1, further comprising utilizing the power that is available from the data network in conjunction with power from an AC-DC adapter or power from a battery.

5. The method of claim 1, further comprising utilizing the power that is available from the data network to provide power for a low power suspend mode or low power hibernation mode of the information handling system.

6. The method of claim 1, further comprising utilizing the power that is available from the data network to provide power for a wake up on LAN mode of the information handling system.

7. The method of claim 1, further comprising communicating with the data network so as to direct the data network to provide no power to the information handling system.

8. A method of controlling the power management system within an information handling system, comprising:
providing power management control circuitry;
coupling the power management control circuitry to network power control circuitry, the network power control circuitry configured to receive power from a data network for operating at least in part at least a portion of the information handling system; and
providing feedback and control amongst the power management control circuitry, the data network power control circuitry, and at least a second power source.

9. The method of claim 8, wherein the data network is an Ethernet network.

10. The method of claim 9, further comprising a third power source, wherein feedback and control is provided between the power management control circuitry and the third power source.

11. The method of claim 10, wherein one of the second and third power sources is an AC-DC adapter and the other of the second and third power sources is a battery.

12. The method of claim 11, wherein at least two batteries are provided.

13. The method of claim 12, wherein at least a first battery may be charged from power received from the data network while at least a second battery is utilized to operate at least a portion of the information handling system.

14. The method of claim 10, further comprising:
characterizing at least one property of the power available from the data network; and
utilizing the characterization of the at least one property of the power available from the data network to manage the power resources of the information handling system.

15. An information handling system, comprising:
at least one battery coupled to the information handling system for providing power to the information handling system;
a data network power circuit configured to be coupled to at least one data network line to receive power from a data network; and
system power management resources coupled to both the battery and the data network power circuit, the system power management resources configured to enable power to be utilized by the information handling system from both the at least one battery and the data network together.

16. The information handling system of claim 15, wherein the data network power circuit is configured to receive power from an Ethernet connection.

17. The information handling system of claim 15, further comprising at least one power connection configured to be coupled to an AC-DC adapter.

18. The information handling system of claim 17, wherein the system power management resources are configured such that the power that is available from the data network may be utilized in conjunction with power from the AC-DC adapter or power from the battery or both.

19. The information handling system of claim 17, wherein the data network power circuit is configured to detect and characterize the power available from the data network.

20. The information handling system of claim 19, wherein a voltage output of the data network power circuit is selectable by the system power management resources.
